(19) United States
(12) Patent Application Publication
(10) Pub. No.: US 2025/0069285 A1
(43) Pub. Date: Feb. 27, 2025

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Risako TANIGAWA, Kanagawa (JP); Shun ISHIZAKA, Tokyo (JP); Kazuki KOZUKA, Osaka (JP)

(73) Assignee: Panasonic Intellectual Property Corporation of America, Torrance, CA (US)

(21) Appl. No.: 18/948,176

(22) Filed: Nov. 14, 2024

Related U.S. Application Data
(63) Continuation of application No. PCT/JP2023/018254, filed on May 16, 2023.
(60) Provisional application No. 63/342,796, filed on May 17, 2022.

(30) Foreign Application Priority Data
Apr. 24, 2023 (JP) 2023-071103

(51) Int. Cl. G06T 11/00; G06F 3/04842; G06F 3/0485; G06T 7/70

(52) U.S. Cl. CPC G06T 11/00; G06F 3/04842; G06F 3/0485; G06T 7/70; G06T 2200/04

(57) ABSTRACT

An information processing device displays, on a display of an information terminal, a first image obtained by photographing a predetermined space on first date and time; and when detecting an instruction to select second date and time different from the first date and time, displays, on the display, a second image obtained by photographing the predetermined space on the second date and time, in which the second image is displayed on the display while having a default viewpoint being changed so as to match a viewpoint of the first image.

### FIELD OF INVENTION

The present disclosure relates to a technique for displaying a selected image.

### BACKGROUND ART

Patent Literature 1 discloses displaying an image (e.g., a contour line) indicating a designated area designated by a worker on a bird's-eye photography image of a work site, and displaying a chat related to the designated area input by the worker in a display field provided next to the bird's-eye photography image.

However, the related art disclosed in Patent Literature 1 fails to disclose that an image obtained by photographing at a site indicated by a bird's-eye photography image is displayed on a display in response to a selection instruction by a user. Therefore, the related art does not disclose displaying, on the display, a second image related to a first image displayed on the display in response to the selection instruction by the user either. Therefore, in the related art, when displaying the second image related to the first image on the display, it is not possible to realize, by simple operation, displaying of the second image on the display such that a subject displayed by the first image is displayed.
Patent Literature 1: JP 2021-86224 A

### SUMMARY OF THE INVENTION

The present disclosure has been made to solve such a problem, and an object of the present disclosure is to provide a technique for realizing, by simple operation, displaying of a second image related to a first image on a display such that a subject displayed by the first image is displayed when displaying the second image on the display.

An information processing method according to one aspect of the present disclosure is an information processing method in a computer, the method including: displaying, on a display of an information terminal, a first image obtained by photographing a predetermined space on first date and time; and when detecting an instruction to select second date and time different from the first date and time, displaying, on the display, a second image obtained by photographing the predetermined space on the second date and time, in which the second image is displayed on the display while having a default viewpoint being changed so as to match a viewpoint of the first image.

When displaying the second image related to the first image on the display, this configuration makes it possible to realize, by simple operation, displaying of the second image on the display such that a subject displayed by the first image is displayed.

### BRIEF DESCRIPTION OF DRAWINGS

FIG. 1 is a block diagram illustrating an example of a configuration of an information processing system in an embodiment of the present disclosure.

FIG. 2 is a view illustrating an example of a display screen displayed on a display of a terminal device.

FIG. 3 is a view illustrating an example of a menu screen for selecting photographing date and time.

FIG. 4 is a view illustrating an example of a first image and a second image displayed on the display.

FIG. 5 is a conceptual view of changing a viewpoint in the present embodiment.

FIG. 6 is a flowchart illustrating one example of processing of an information processing device shown in FIG. 1.

FIG. 7 is a flowchart illustrating details of display processing illustrated in FIG. 6.

FIG. 8 is an explanatory view of a first image and a second image according to a modified example of the present disclosure.

### DETAILED DESCRIPTION

### (Circumstances Leading to One Aspect of Present Disclosure)

Problems at a construction site include communication problems such as that a specific instruction is not transmitted to a worker and that it takes time to explain the instruction, and problems of confirmation of a construction site such as that it requires many people to go around the entire construction site and that it takes time to move to the construction site.

In order to solve such problems, for example, it is conceivable that a large number of cameras are installed at a construction site, and a site supervisor at a remote place gives an instruction to a worker while referring to images obtained from the large number of cameras. However, at a construction site, as construction progresses, work occurs such as removing an installed sensor or installing the removed sensor at another place. Since such work takes time and effort, it is not practical to install a sensor at a construction site. Therefore, the inventors of the present invention have studied a technique enabling remote check of a situation of a construction site in detail without installing a sensor.

Then, it has been found that, when operation of selecting photographing date on a design drawing of a construction site displayed on a display is input, a photography point of an image obtained by photographing on the photographing date is superimposed and displayed on the design drawing, and when an instruction to select the photography point is input, if there is a user interface that displays an image obtained by photographing at the selected photography point, a situation of the construction site can be remotely checked in detail.

Meanwhile, in the image displayed in this manner, a subject of user's interest may be photographed while being blocked by another subject. Furthermore, if a subject of interest can be observed with another line of sight, such a subject can be observed in more detail.

In this case, if a second image obtained by photographing the same construction site as a first image on different photographing date and photographed near the first image is displayed on the display, the user can observe the subject of interest in more detail.

However, the first image and the second image may be displayed in a display mode in which a part of a region centered on a default viewpoint corresponding to a predetermined direction (e.g., a direction parallel to a horizontal plane and facing north) is displayed on the display in some cases. For example, it is a case where a wide-angle image such as an omnidirectional image or a panoramic image is adopted as the first image and the second image. When such a display mode is adopted, there is a possibility that the second image cannot be displayed so as to include the subject of interest depending on a default viewpoint of the second image. In this case, the user is required to conduct operation of scrolling the second image to display the subject of interest on the display, which takes time and effort. Furthermore, since the scroll operation involves processing of scrolling an image, a processing load on a computer increases.

Therefore, the present inventors have obtained findings that such a problem can be solved by changing and displaying the default viewpoint of the second image related to the first image so as to match a viewpoint of the first image when the second image is displayed on the display, and have arrived at the present disclosure.

(1) An information processing method according to one aspect of the present disclosure is an information processing method in a computer, the method including: displaying, on a display of an information terminal, a first image obtained by photographing a predetermined space on first date and time; and when detecting an instruction to select second date and time different from the first date and time, displaying, on the display, a second image obtained by photographing the predetermined space on the second date and time, in which the second image is displayed on the display while having a default viewpoint being changed so as to match a viewpoint of the first image.

According to this configuration, in a case of displaying the second image obtained by photographing at date and time different from that of the first image, the second image whose default viewpoint has been changed to match the viewpoint of the first image is displayed. Therefore, without conducting time-consuming operation of scrolling the second image to display a subject displayed by the first image on the display, a user can display the subject of interest in the second image. Furthermore, since such scroll operation is unnecessary, a processing load on the computer can be reduced.

(2) The information processing method according to (1) described above may further include displaying, on the display, an overhead view image of the predetermined space, the overhead view image in which a plurality of photography point icons indicating photography points on the first date and time are displayed in a superimposed manner; and detecting selection of one photography point icon from among the plurality of photography point icons, in which the first image may be an image obtained by photographing at a photography point indicated by the one photography point icon.

According to this configuration, the first image can be intuitively selected from the overhead view image.

(3) In the information processing method according to (1) or (2) described above, among a plurality of images obtained by photographing on the second date and time, the second image may be an image obtained by photographing the predetermined space at a photography point closest to a photography point of the first image.

According to this configuration, it is possible to display a second image having a high possibility of displaying a subject included in the first image without inputting operation of selecting one image from the plurality of images obtained by photographing on the second date and time.

(4) In the information processing method according to any one of (1) to (3) described above, the change of the default viewpoint in the second image may include: detecting a corresponding point of the viewpoint of the first image from the second image based on the first image; and setting the detected corresponding point as a viewpoint of the second image.

According to this configuration, since the corresponding point of the viewpoint of the first image is set as the viewpoint of the second image, the viewpoint of the second image can be accurately adjusted to the viewpoint of the first image.

(5) In the information processing method according to any one of (1) to (4) described above, the viewpoint of the first image may be a center of a display region of the first image displayed on the display, and a viewpoint of the second image may be a center of a display region of the second image displayed on the display.

This configuration brings each of the first image and the second image having an image in each display region centered on each viewpoint to be displayed on the display.

(6) The information processing method according to any one of (1) to (5) described above may further include, when detecting an instruction to scroll the first image, scrolling the first image in accordance with the scroll instruction, and scrolling the second image in conjunction with the scrolling of the first image.

According to this configuration, when the first image is scrolled, the second image is also scrolled in conjunction with the scrolling of the first image, which facilitates comparison between both the images.

(7) The information processing method according to any one of (1) to (6) described above may further include, when failing to detect a corresponding point of the viewpoint of the first image from the second image, detecting a corresponding point of the default viewpoint of the second image from the first image, and changing the viewpoint of the first image to the detected viewpoint and displaying the first image on the display.

According to this configuration, even when the corresponding point of the viewpoint of the first image cannot be detected from the second image, the first image and the second image can be displayed so that the same subject is displayed.

(8) In the information processing method according to any one of (1) to (7) described above, the predetermined space may be a work site.

According to this configuration, a situation of the work site can be easily grasped.

(9) In the information processing method according to any one of (1) to (8) described above, the first image and the second image may be displayed side by side on the display.

According to this configuration, comparison between the first and second images is facilitated.

(10) An information processing device according to another aspect of the present disclosure is an information processing device including a processor, in which the processor displays, on a display of an information terminal, a first image obtained by photographing a predetermined space on first date and time; and when detecting an instruction to select second date and time different from the first date and time, displaying, on the display, a second image obtained by photographing the predetermined space on the second date and time, the second image being displayed on the display while having a default viewpoint being changed so as to match a viewpoint of the first image.

According to this configuration, it is possible to provide an information processing device that, when displaying the second image related to the first image on the display, enables, by simple operation, the second image to be displayed on the display such that the subject displayed by the first image is displayed.

(11) An information processing program according to still another aspect of the present disclosure causes a computer to execute the information processing method according to any one of (1) to (9) described above.

According to this configuration, it is possible to provide an information processing program that, when displaying the second image related to the first image on the display, enables, by simple operation, the second image to be displayed on the display such that the subject displayed by the first image is displayed.

The present disclosure can be also implemented as an information processing system that is operated by such an information processing program. In addition, it is needless to say that the present disclosure allows such an information processing program to be distributed using a computer-readable non-transitory recording medium such as a CD-ROM, or via a communication network such as the Internet.

Each of embodiments described below illustrates a specific example of the present disclosure. Numerical values, shapes, components, steps, an order of steps, and the like shown in the embodiments below are merely one example, and are not intended to limit the present disclosure. Furthermore, a component that is not described in an independent claim representing the highest concept among components in the embodiments below will be described as an arbitrary component. In all the embodiments, respective contents can be combined.

### Embodiments

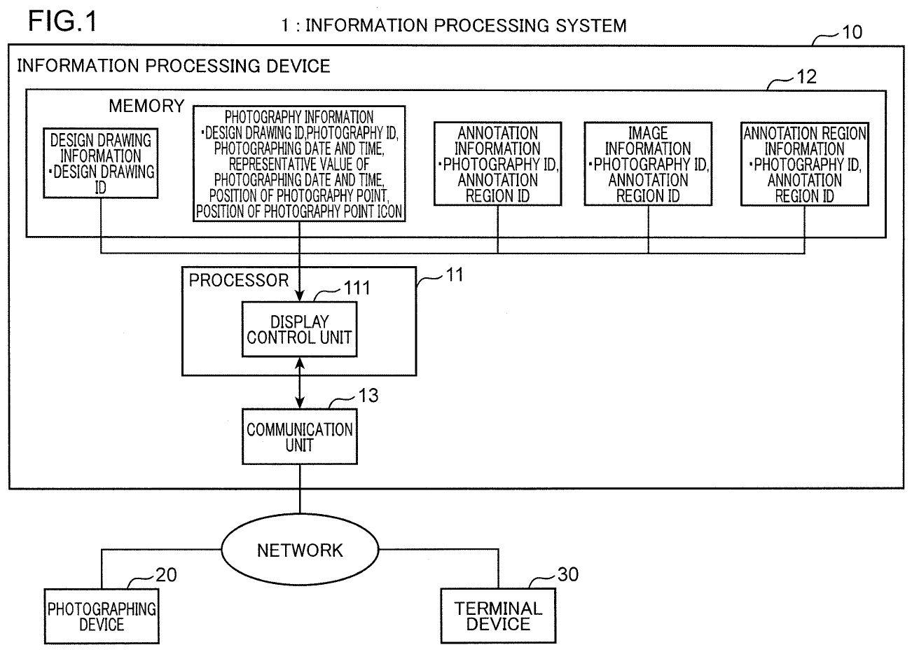

FIG. 1 is a block diagram illustrating an example of a configuration of an information processing system 1 in an embodiment of the present disclosure. The information processing system 1 includes an information processing device 10, a photographing device 20, and a terminal device 30. The information processing device 10, the photographing device 20, and the terminal device 30 are communicably connected via a network. The network is, for example, the Internet. The information processing device 10 is, for example, a cloud server including one or a plurality of computers. Note that this is an example, and the information processing device 10 may be configured by an edge server or may be implemented in the terminal device 30.

The photographing device 20 is configured by, for example, an omnidirectional camera, and photographs an image at a predetermined frame rate. The photographing device 20 is, for example, a portable photographing device carried by a user. Examples of the user are a worker at a construction site and a site supervisor. The user moves in the construction site while photographing the construction site with the photographing device 20. The photographing device 20 transmits image information indicating the photographed image to the information processing device 10 via the network. In the image information, a position of a photography point indicating the photography point is associated with photographing date and time. The position of the photography point is acquired by, for example, a position sensor such as a magnetic sensor or a GPS sensor included in the photographing device 20, and is represented by latitude and longitude. The photographing date and time is acquired by, for example, a clock included in the photographing device 20. As a result, the information processing device 10 can obtain image information at a plurality of photography points in the construction site. Here, since the photographing device 20 photographs an image at a predetermined frame rate, the photography point is defined on a frame period basis. However, this is an example, and the photography point may be defined every predetermined time (e.g., one second, one minute, etc.). The photographing device 20 includes an image sensor, an operation device, a communication circuit, a signal processing circuit, and the like. The photographing device 20 may be configured by a portable computer such as a smartphone or a tablet computer.

The terminal device 30 is carried by the user. The terminal device 30 may be configured by, for example, a portable computer such as a smartphone or a tablet computer, or may be configured by a stationary computer. The terminal device 30 displays the image information on the display under the control of the information processing device 10. Although one terminal device 30 is illustrated in the example of FIG. 1, a plurality of terminal devices may be connected to the information processing device 10 via the network. The terminal device 30 includes a central processing unit (CPU), a memory, a display, an operation device such as a touch panel and a keyboard, and a communication circuit.

The information processing device 10 includes a processor 11, a memory 12, and a communication unit 13. The processor 11 is configured by, for example, a central processing unit (CPU). The processor 11 includes a display control unit 111. The display control unit 111 may be realized by the processor 11 executing the information processing program, or may be configured by a dedicated hardware circuit such as an ASIC.

The display control unit 111 acquires an instruction to select a design drawing from the user from the terminal device 30, reads design drawing information indicated by the instruction from the memory 12, and displays the read design drawing information on the display of the terminal device 30. The design drawing information is information indicating a design drawing of a construction site (an example of a predetermined space). The design drawing information is an example of an overhead view image. The display control unit 111 superimposes and displays, on the design drawing, a photography point icon for selecting an arbitrary position in the design drawing. When acquiring an instruction to select first date and time by the user from the terminal device 30, the display control unit 111 superimposes and displays, on the design drawing, a plurality of photography point icons indicating photography points on the first date and time. These displays are realized by the display control unit 111 transmitting a display instruction to the terminal device 30 using the communication unit 13. A selection icon is configured to be movable on the design drawing. In the design drawing, latitude and longitude are associated in advance with a position to be a key point. The position serving as a key point includes, for example, positions at four corners of the design drawing.

The display control unit 111 detects selection of one photography point icon by acquiring an instruction to select one photography point icon from among the plurality of photography point icons from the terminal device 30. When detecting the selection of the one photography point icon, the display control unit 111 displays a first image photographed at a photography point indicated by the one photography point icon on the display of the terminal device 30. The first image is an omnidirectional image. Note that this is an example, and the first image may be a panoramic image. Therefore, the display control unit 111 sets a display region centered on a default viewpoint of the first image, and transmits a display instruction to display the first image in the set display region on the display to the terminal device 30 using the communication unit 13. As a result, the terminal device 30 displays the first image included in the display region centered on the default viewpoint on the display. The default viewpoint is a viewpoint set as an initial value, and is, for example, a direction parallel to a horizontal plane and facing north.

When detecting an instruction to scroll the first image input by the user from the terminal device 30, the display control unit 111 transmits a display instruction to scroll the first image in accordance with an operation amount indicated by the detected scroll instruction to the terminal device 30. As a result, the terminal device 30 can change the display region of the first image. In this case, a viewpoint of the first image becomes center coordinates of the display region after scrolling. The display region of the first image has, for example, a size and shape predetermined according to a size and shape of a display area of the first image on the display of the terminal device 30. The shape of the display area is, for example, quadrangle.

When acquiring, from the terminal device 30, an instruction to select second date and time that is different date and time from the first date and time, to detect the instruction to select the second date and time, the display control unit 111 displays a second image obtained by photographing the construction site at the second date and time on the display of the terminal device 30. Specifically, the display control unit 111 decides an image obtained by photographing the construction site at a photography point closest to the photography point of the first image among the plurality of images photographed on the second date and time, and

displays the decided image on the display of the terminal device 30 as the second image. A configuration of the second image is the same as that of the first image.

The display control unit 111 changes a default viewpoint of the second image so as to match the viewpoint of the first image, and displays the second image with the changed default viewpoint on the display of the terminal device 30. Specifically, the display control unit 111 detects a corresponding point of the viewpoint of the first image from the second image, and sets the detected corresponding point as the viewpoint of the second image. Then, the display control unit 111 sets a display region of the second image centered on the set viewpoint of the second image, and transmits a display instruction to display the second image in the set display region on the display to the terminal device 30 using the communication unit 13. As a result, the terminal device 30 can display, on the display, the second image having the display region set to include a subject included in the display region of the first image. For example, the display control unit 111 may detect a corresponding point from the second image by applying pattern matching using the display region of the first image as a template to the second image. The display region of the second image has, for example, a predetermined size and shape according to a size and shape of a display area of the second image on the display of the terminal device 30. The shape of the display area is, for example, quadrangle. Here, it is assumed that the display area of the first image and the display area of the second image have the same size and shape. In addition, it is assumed that the display area of the first image and the display area of the second image are provided side by side. As a result, the first image and the second image are displayed side by side.

The memory 12 is configured with a nonvolatile rewritable storage device such as a hard disk drive or a solid state drive. The memory 12 stores design drawing information, photography information, annotation information, image information, and annotation region information. The design drawing information is image information indicating a design drawing. The design drawing information is associated with a design drawing ID for identifying a design drawing. In the design drawing, as described above, the latitude and longitude of the actual construction site are set as a key point.

The photography information indicates information regarding one photographing operation using the photographing device 20. The photography information is generated every time one photographing operation is conducted. One photographing operation refers to a series of operations from start to end of photographing by the worker with the photographing device 20 at the construction site. A plurality of images are photographed by one photographing operation. The photography information includes the design drawing ID, a photography ID, photographing date and time, a representative value of the photographing date and time, a position of a photography point, and a position of a photography point icon. The photography ID is an identifier for identifying each photographing included in one photographing operation. The photographing date and time is photographing date and time of photographing indicated by the photography ID. The representative value of the photographing date and time is photographing date and time when photographing is started. The first date and time and the second date and time refer to representative values of the photographing date and time. The photography point indicates a position (latitude and longitude) at which photographing indicated by the photography ID is conducted. The position of the photography point icon indicates a display position (coordinates), on the design drawing, of the photography point icon corresponding to the photography ID. The position of the photography point icon is calculated by mapping a photographing position on the design drawing based on a photographing position (latitude and longitude) at the key point of the design drawing indicated by the design drawing information and a photography point (latitude and longitude) corresponding to the photography ID.

The annotation information is information indicating an annotation. One piece of annotation information corresponds to one annotation. The annotation information is associated with the photography ID and an annotation region ID. The annotation region ID is an identifier of an annotation region set in the image information corresponding to the photography ID, the annotation region being applied an annotation.

The image information indicates one image obtained by each photographing included in one photographing operation. In other words, the image information indicates the first image or the second image described above. The photography ID and the annotation region ID are associated with the image information. In a case where a plurality of annotation regions are set in the image information corresponding to the photography ID, the image information includes a plurality of annotation region ID.

The annotation region information stores a position (coordinates) of a key point in the annotation region set in the image information corresponding to the photography ID. The key point is a vertex on an outline of the annotation region. The annotation region information is associated with the photography ID and the annotation region ID.

As described above, since the photography ID is associated with the photography information and the image information, image information corresponding to the photography point icon is specified using the photography ID as a key. Since the annotation information and the annotation region information are associated with the annotation region ID, annotation information corresponding to the annotation region information is specified using the annotation region ID as a key. Since the annotation region information and the image information are associated with the photography ID, image information corresponding to the annotation region information is specified using the photography ID as a key.

The communication unit 13 is a communication circuit that connects the information processing device 10 to the network.

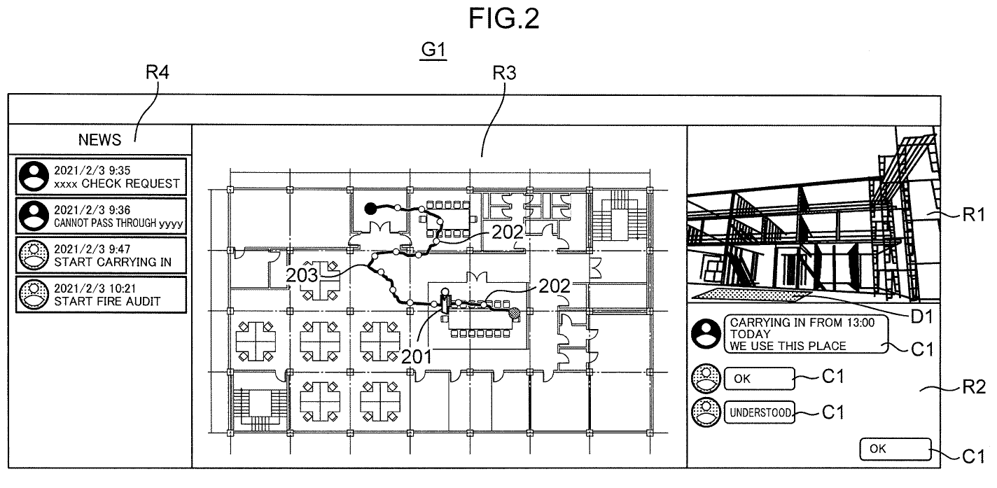

FIG. 2 is a view illustrating an example of a display screen G1 displayed on the display of the terminal device 30. The display screen G1 is a basic screen of an application provided by the information processing device 10. The display screen G1 includes an image information display field R1, an annotation information display field R2, a design drawing display field R3, and a news display field R4.

The image information display field R1 displays image information associated with one photography point icon decided by the display control unit 111.

The annotation information display field R2 displays annotation information associated with the decided one photography point icon. Here, annotations C1 input by a plurality of users with respect to the image information displayed in the image information display field R1 are displayed in a list form. In the annotation information display field R2, the annotation C1 input by a user other than the user himself/herself is displayed on the left side, and the annotation C1 input by the user himself/herself is displayed on the right side.

On a default display screen G1 immediately after the start of the application, a photography point icon is yet to be selected by the user. Therefore, on the default display screen G1, the image information display field R1 and the annotation information display field R2 are blank.

The design drawing display field R3 displays a design drawing of the construction site. In the design drawing displayed in the design drawing display field R3, a selection icon 201, a photography point icon 202, and a trajectory 203 are displayed in a superimposed manner.

The selection icon 201 is configured to be movable by drag and drop operation. In this example, the selection icon 201 is configured by an image simulating a person.

The photography point icon 202 is an icon indicating a photography point, and is associated with image information. In this example, the photography point icon 202 is configured by a circular image. The trajectory 203 indicates a trajectory of a user who has photographed the image information. In this example, the trajectory 203 is configured by a line connecting adjacent photography point icons 202. The photography point icon 202 located at a leading end of the trajectory 203 and the photography point icon 202 located at a trailing end of the trajectory 203 are displayed in a larger size than the other photography point icons. The photography point icon 202 located at the leading end (e.g., a right end) of the trajectory 203 indicates a photographing start position, and the photography point icon 202 located at the trailing end (e.g., a left end) of the trajectory 203 indicates a photographing end position.

When operation (e.g., tap or click) of selecting an image displayed in the image information display field R1 is input, the design drawing display field R3 displays the image displayed in the image information display field R1 in the design drawing display field R3.

The news display field R4 displays various messages related to the construction site and input by the user.

For example, when the selection icon 201 is dropped in a predetermined region of any of the photography point icons 202, the photography point icon 202 is decided as one photography point icon, and an image corresponding to the one photography point icon is detected as the first image. Then, the first image is displayed in the image information display field R1. In this case, when the annotation information is associated with the one photography point icon, the annotation information corresponding to the one photography point icon is displayed in the annotation information display field R2.

For example, it is assumed that the selection icon 201 is not dropped in the predetermined region in any of the photography point icons 202. In this case, a photography point icon having the shortest distance to the dropping position and associated with the annotation information is decided as one photography point icon, and an image corresponding to the one photography point icon is detected as the first image. Then, the first image is displayed in the image information display field R1, and annotation information corresponding to the first image is displayed in the annotation information display field R2.

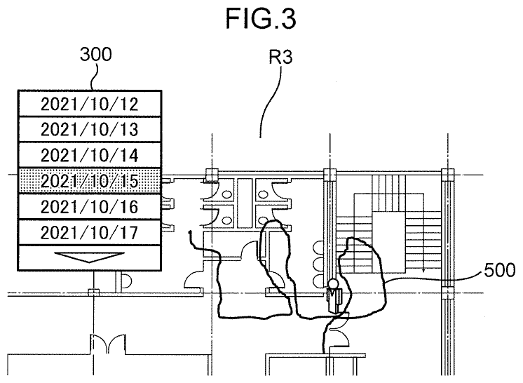

FIG. 3 is a view illustrating an example of a menu screen 300 for selecting photographing date and time. The menu screen 300 is displayed when predetermined operation for displaying the menu screen 300 is conducted on the display screen G1. The menu screen 300 displays a list of a plurality of photographing dates and times of photographing at one construction site. One photographing date and time included in the menu screen 300 indicates a representative value of photographing date and time of one photographing operation.

In a case where the user inputs an instruction to select one photographing date and time from the menu screen 300, the display control unit 111 acquires the instruction from the terminal device 30. Then, the display control unit 111 transmits, to the terminal device 30, a display instruction to superimpose and display a trajectory 500 corresponding to photographing date and time indicated by the acquired instruction in the design drawing display field R3. As a result, the user can display the trajectory 500 corresponding to the selected photographing date and time on the design drawing display field R3. In the display screen G1 that is first displayed after the application is activated, the trajectory 500 corresponding to the latest photographing date and time is displayed in the design drawing display field R3. Although in FIG. 3, the photography point icon 202 is omitted for convenience of description, the photography point icon 202 is actually also displayed as illustrated in FIG. 2.

When operation of selecting the first image displayed in the image information display field R1 is input, the design drawing display field R3 displays the first image. In this state, when operation is input from the menu screen 300, the operation for selecting the second date and time that is the photographing date and time different from the first date and time that is the photographing date and time corresponding to the first image, the display control unit 111 displays the first image and the second image side by side in the design drawing display field R3. The second image is an image whose photography point is closest to the first image among the plurality of images obtained by photographing at the second date and time. For example, the display control unit 111 calculates a distance between coordinates of each of photography point icons of the plurality of images obtained by photographing on the second date and time and coordinates of a photography point icon of the first image, and decides an image corresponding to the photography point icon with the shortest distance as the second image.

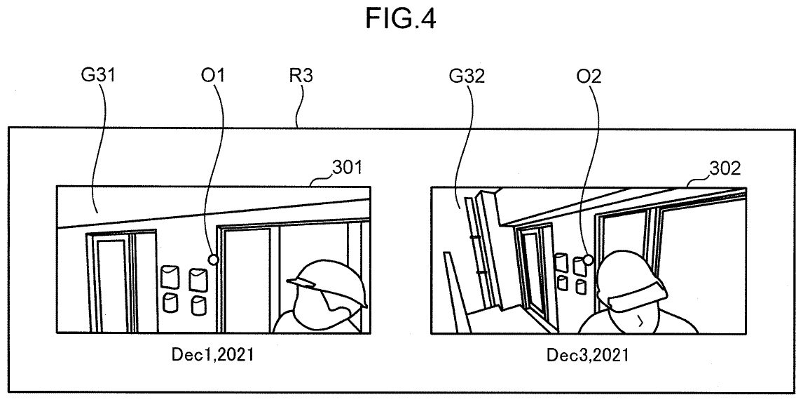

FIG. 4 is a view illustrating an example of a first image G31 and a second image G32 displayed on the display. As illustrated in FIG. 4, the first image G31 and the second image G32 are displayed in the design drawing display field R3. In this example, a design drawing originally displayed in the design drawing display field R3 is hidden. The design drawing display field R3 displays the first image G31 on the left side and the second image G32 on the right side. A circle at the center of the first image G31 is a viewpoint O1 of the first image G31. A circle at the center of the second image G32 is a viewpoint O2 of the second image G32. In this example, although the circles indicating the viewpoints O1 and O2 are illustrated for convenience of description, these circles are not actually displayed. The viewpoint O1 is located at the center of a display region 301 of the first image G31, and the viewpoint O2 is located at the center of a display region 302 of the second image G32. Photographing dates of the first image G31 and the second image G32 are displayed below the first image G31 and the second image G32.

The display control unit 111 detects a corresponding point of the viewpoint O1 from the second image G32 by executing pattern matching using the first image G31 in the display region 301 as a template with respect the entire region of the second image. The display control unit 111 sets the detected corresponding point as the viewpoint O2, sets a certain region centered on the viewpoint O2 as the display region 302, and displays the second image G32 included in the display region 302 on the display of the terminal device 30.

When the display region 302 is set centered on the default viewpoint to display the second image G32, there is a possibility that a subject of user's interest included in the display region 301 of the first image G31 is not displayed in the display region 302. In this case, the user is required to perform operation of scrolling the second image G32 in order to display the subject of interest in the display region 302, which takes time and effort.

Therefore, in the present embodiment, the second image G32 is displayed with the display region 302 set centered on the viewpoint O2 that is the corresponding point of the viewpoint O1. As a result, the second image G32 is displayed on the display such that the viewpoint O2 matches the viewpoint O1. As a result, the subject included in the display region 301 can be observed with another line of sight without scrolling the second image G32. Furthermore, even when the subject of interest in the display region 301 is blocked by another subject, the user can observe the subject of interest in the display region 302 without scrolling the second image G32.

When detecting an instruction to scroll the first image G31, the display control unit 111 may scroll the first image G31 in accordance with the scroll instruction, and scroll the second image G32 in conjunction with the scrolling of the first image G31. For example, when operation amounts in a horizontal direction and a vertical direction indicated by the scroll instruction are Δx and Δy, respectively, the display control unit 111 may display the first image G31 and the second image G32 in conjunction with each other by shifting the viewpoints of the first image G31 and the second image G32 by Δx and Δy, respectively. When detecting an instruction to scroll the second image G32, the display control unit 111 may scroll the second image G32 in accordance with the scroll instruction, and scroll the first image G31 in conjunction with the scrolling of the second image G32.

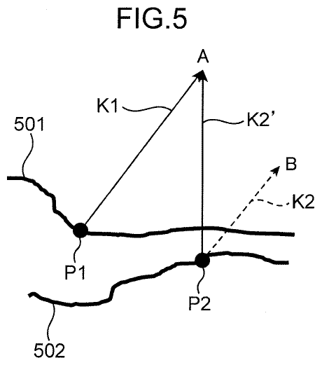

FIG. 5 is a conceptual view of changing a viewpoint in the present embodiment. A line-of-sight direction K1 is a direction from a photography point P1 of the first image G31 toward a subject A corresponding to the viewpoint of the first image G31. A line-of-sight direction K2 is a direction from a photography point P2 of the second image G32 toward a subject B corresponding to a default viewpoint of the second image G32. A trajectory 501 is a trajectory on the first date and time, and a trajectory 502 is a trajectory on the second date and time. Since the subject B is away from the subject A, when the display region 302 is set centered on the default viewpoint to display the second image G32, the subject A might not be displayed in the display region 302 of the second image G32. Therefore, the display control unit 111 changes the default viewpoint of the second image G32 to the viewpoint of the first image G31 and sets the display region 302 centered on the changed viewpoint to display the second image G32. This causes the line-of-sight direction K2 to be changed to a line-of-sight direction K2′, and the viewpoint of the second image G32 is changed to match the viewpoint of the first image G31. As a result, the subject A is displayed in the display region 302 of the second image G32.

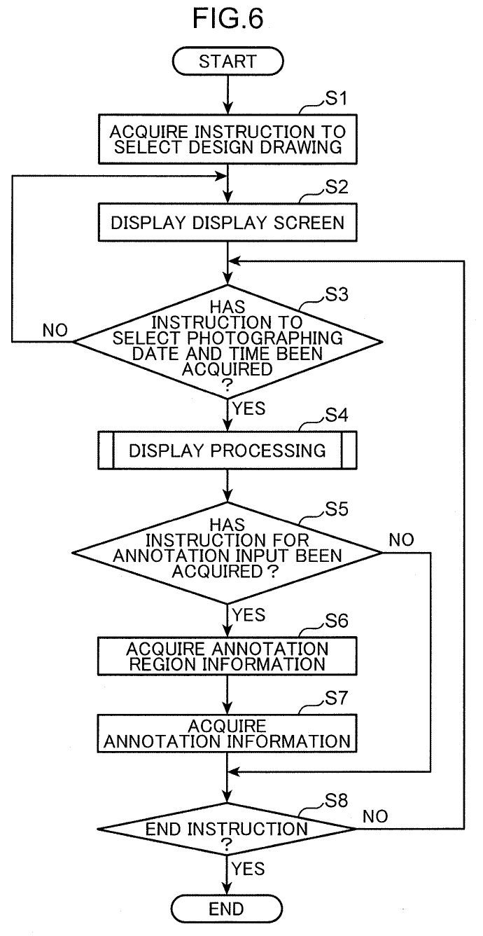

FIG. 6 is a flowchart illustrating one example of processing of the information processing device 10 shown in FIG. 1. The display control unit 111 acquires an instruction from a user who selects a design drawing (Step S1). In this case, a menu screen for selecting a design drawing is displayed on the display of the terminal device 30, and an instruction to select one design drawing from the menu screen is input. The input instruction is transmitted to the information processing device 10 via the network and received by the communication unit 13. The display control unit 111 acquires the instruction via the communication unit 13. Since this instruction includes the design drawing ID, the display control unit 111 can acquire design drawing information indicating an instructed design drawing from the pieces of the design drawing information stored in the memory 12.

Next, the display control unit 111 displays the display screen G1 on the display of the terminal device 30 by transmitting a display instruction on the display screen G1 to the terminal device 30 via the communication unit 13 (Step S2). The display instruction on the display screen G1 displayed as default includes the design drawing information indicating the design drawing selected in Step S1 and photography information corresponding to the latest photographing date and time. Therefore, as illustrated in FIG. 2, the display screen G1 displayed as default includes the selection icon 201, and the photography point icon 202 and the trajectory 203 corresponding to the latest photographing date and time in the design drawing. At this time point, since one photography point icon is yet to be decided, the image information display field R1 and the annotation information display field R2 are blank. Note that, in a case where an instruction to select the photographing date and time is input in Step S3 to be described later, the display control unit 111 displays, on the display, the display screen G1 including a design drawing on which the photography point icon 202 and the trajectory 203 corresponding to the selected photographing date and time are superimposed and displayed.

Next, the display control unit 111 determines whether or not an instruction from the user for selecting the photographing date and time has been acquired (Step S3). In this case, the menu screen 300 for selecting photographing date and time is displayed on the display of the terminal device 30. The user inputs an instruction to select one photographing date and time from the menu screen 300. The photographing date and time displayed on the menu screen 300 is a representative value of the photographing date and time included in the photography information stored in the memory 12. When the photographing date and time is selected, one photographing operation corresponding to the photographing date and time is selected. The input instruction is transmitted to the information processing device 10 via the network and received by the communication unit 13. The display control unit 111 acquires the instruction via the communication unit 13. Since this instruction includes the representative value of the photographing date and time, the display control unit 111 can specify one piece of the photography information stored in the memory 12. When the instruction to select the photographing date and time is input (YES in Step S3), the processing proceeds to Step S4. When the instruction to select the photographing date and time is not input (NO in Step S3), the processing returns to Step S2.

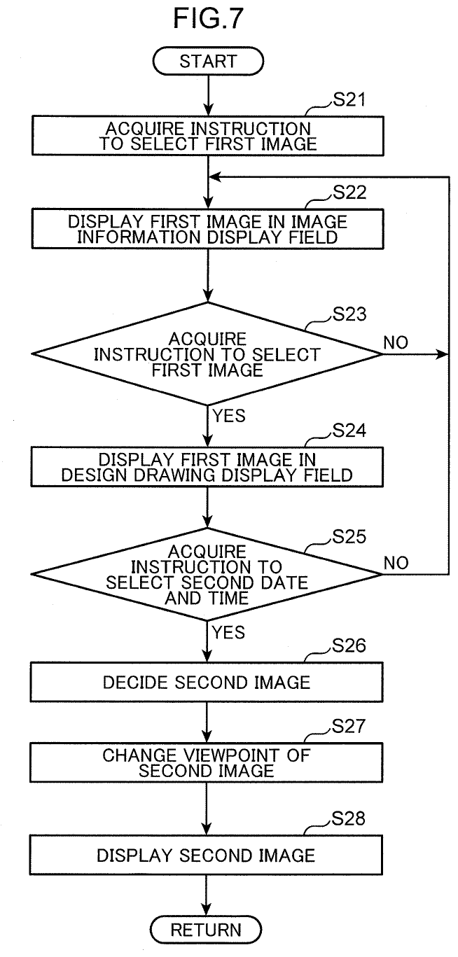

Next, display processing is executed (Step S4). Details of the display processing will be described later with reference to FIG. 7. The display processing is processing of displaying the first image and the second image side by side in the design drawing display field R3.

Next, the display control unit 111 determines whether or not an annotation input instruction has been acquired (Step S5). The annotation input instruction is an instruction input when the user intends to input an annotation to the image displayed in the image information display field R1. This instruction is input, for example, by conducting operation of selecting an annotation input instruction button (not illustrated) displayed on the display screen G1. The input instruction is transmitted to the information processing device 10 via the network and received by the communication unit 13. The display control unit 111 acquires the instruction via the communication unit 13.

Next, when the annotation input instruction has been acquired (YES in Step S5), the display control unit 111 acquires the annotation region information (Step S6). The annotation region information is input by conducting operation of moving and deforming, for example, a rectangular frame body in the image information display field R1. The input annotation region information is transmitted to the information processing device 10 via the network and received by the communication unit 13. The display control unit 111 acquires annotation region information via the communication unit 13. The display control unit 111 assigns an annotation region ID to the acquired annotation region information, and stores the annotation region ID in the memory 12 in association with the photography ID. As a result, the annotation region DI is set as illustrated in FIG. 3.

Next, in a case where the annotation input instruction is yet to be acquired (NO in Step S5), the processing proceeds to Step S8.

Next, the display control unit 111 acquires the annotation information (Step S7). As illustrated in FIG. 3, the annotation information is input by inputting the annotation C1 to the annotation information display field R2 and pressing a transmission button (not illustrated). The input annotation information is transmitted to the information processing device 10 via the network and received by the communication unit 13. The display control unit 111 acquires the annotation information via the communication unit 13. The display control unit 111 stores the acquired annotation information in the memory 12 in association with the photography ID and the annotation region ID.

Next, the display control unit 111 determines whether or not an end instruction has been acquired (Step S8). The end instruction is an instruction to close the display screen G1 displayed in Step S3. This instruction is input by conducting operation of pressing an end button (not illustrated) displayed on the display screen G1. In a case where the end instruction has been acquired (YES in Step S8), the processing ends. In a case where the end instruction is yet to be acquired (NO in Step S8), the processing returns to Step S3. In this case, the display of the display screen G1 is maintained. The end instruction is transmitted to the information processing device 10 via the network and received by the communication unit 13. The display control unit 111 acquires the end instruction via the communication unit 13.

FIG. 7 is a flowchart illustrating details of the display processing illustrated in FIG. 6. The display control unit 111 acquires an instruction to select the first image (Step S21). As illustrated in FIG. 2, this instruction is performed by conducting the operation of dragging and dropping the selection icon 201 on the design drawing. As described above, the display control unit 111 decides one photography point icon selected by the user based on the dropping position of the selection icon 201 and the position of the photography point icon 202, and detects an image corresponding to the one photography point icon as the first image.

Next, the display control unit 111 displays the first image in the image information display field R1 (Step S22). Next, the display control unit 111 determines whether or not the instruction to select the first image displayed in the image information display field R1 has been acquired from the terminal device 30 (Step S23). This instruction is performed by tapping or clicking the first image displayed in the image information display field R1.

When the instruction to select the first image has been acquired (YES in Step S23), the display control unit 111 displays the first image in the design drawing display field R3 (Step S24). On the other hand, when the instruction to select the first image is yet to be acquired (NO in Step S23), the processing returns to Step S22.

Next, the display control unit 111 determines whether or not an instruction to select the second date and time has been acquired from the terminal device 30 (Step S25). This instruction is performed by selecting one photographing date and time from the photographing dates and times displayed as a list on the menu screen 300 illustrated in FIG. 3.

When the instruction to select the second date and time has been acquired (YES in Step S25), the display control unit 111 decides, as the second image, an image whose photography point is closest to the first image among the plurality of images obtained by photographing at the second date and time (Step S26). When the instruction to select the second date and time is yet to be acquired (NO in Step S25), the processing returns to Step S22.

Next, the display control unit 111 changes the viewpoint of the second image to match the viewpoint of the first image (Step S27). This processing is conducted by detecting a corresponding point of the viewpoint of the first image from the second image by pattern matching as described above. As a result, the default viewpoint of the second image is changed to match the viewpoint of the first image.

Next, the display control unit 111 sets a display region of the second image centered on the decided viewpoint, and transmits a display instruction to display the second image in the set display region to the terminal device 30, thereby displaying the second image on the display of the terminal device 30 (Step S28). As a result, as illustrated in FIG. 4, the second image is displayed such that the subject included in the display region 301 of the first image G31 is included in the display region 302 of the second image G32. When the processing of Step S28 ends, the processing proceeds to Step S5 of FIG. 6.

As described above, according to the present embodiment, in a case of displaying the second image obtained by photographing at date and time different from that of the first image, the second image whose default viewpoint has been changed to match the viewpoint of the first image is displayed. Therefore, without conducting time-consuming operation of scrolling the second image to display a subject included in the display region of the first image on the display, the user can display the subject of interest in the second image. Furthermore, since such scroll operation is unnecessary, a processing load on the computer can be reduced.

The present disclosure can adopt the following modified examples.

(1) In Step S27 in FIG. 7, the corresponding point of the viewpoint of the first image may not be detected from the second image in some cases. For example, there is a case where a subject such as a building under construction to be included in the display region of the first image is blocked by another subject such as a person or a building material. In this case, the display control unit 111 may change the viewpoint of the first image so that the viewpoint of the first image matches the default viewpoint of the second image. For example, the display control unit 111 may detect a corresponding point of the default viewpoint of the second image from the first image, set a display range of the first image centered on the detected corresponding points, and display the first image. In detail, the display control unit 111 may detect a corresponding point corresponding to the default viewpoint of the second image from the first image by applying, to the entire region of the first image, pattern matching using the display region of the second image centered on the default viewpoint as a template.

(2) An overhead view may be a room layout showing a room layout in a house. In this case, the present disclosure can be applied to renovation of interior of the house. In addition, the overhead view may be a layout diagram simply illustrating a room layout of the house.

(3) Although in the above embodiment, the construction site is exemplified as a site, the present disclosure is not limited thereto, and a manufacturing site, a logistics site, a distribution site, an agricultural land, a civil engineering site, a retail site, an office, a hospital, a commercial facility, a nursing care facility, or the like may be employed as the site.

(4) Although in the above embodiment, the second image G32 is an image obtained by photographing a predetermined space at the second date and time, the present disclosure is not limited thereto. For example, the second image G32 may be a virtual image generated by rendering a three-dimensional model of a predetermined space. The three-dimensional model may be a model generated based on three-dimensional measurement data or a model generated based on building information modeling (BIM) data. In this case, the date and time when the three-dimensional model was photographed by a virtual camera is the second date and time.

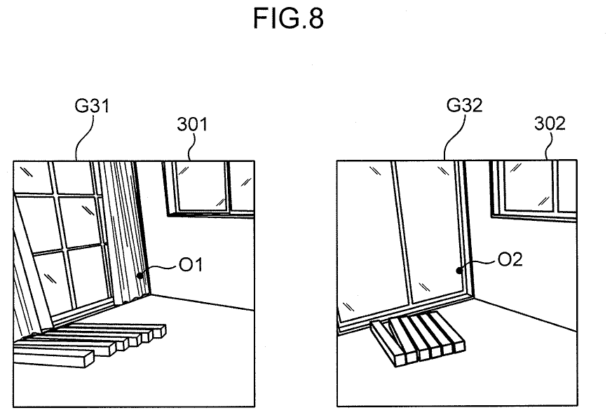

FIG. 8 is an explanatory view of the first image G31 and the second image G32 according to a modified example of the present disclosure. Note that, in the example of FIG. 8, the viewpoint O2 indicates a viewpoint of the second image G32 before the viewpoint is changed. In the example of FIG. 8, the first image G31 is an image obtained by actually photographing the construction site, and the second image G32 is a virtual image obtained by rendering a three-dimensional model of the same construction site. For example, when detecting the instruction to select the second date and time after the first image G31 is displayed, the display control unit 111 displays the second image G32 such that the viewpoint O2 of the second image G32 matches the viewpoint O1 of the first image G31.

Furthermore, in a case where in the first image G31, the scroll operation is input and the viewpoint O1 becomes the center of the display region 301, the display control unit 111 changes the viewpoint O2 of the second image G32 to match the viewpoint O1. In other words, the display control unit 111 scrolls the second image G32 in conjunction with the scrolling of the first image G31. This enables the user to easily check whether or not an actual situation of the construction site is proceeding as shown by the virtual image.

Details of the processing in this modified example are as follows. In a case where the first image G31 is an omnidirectional image, the second image G32 is generated in advance by photographing a three-dimensional model with a virtual camera including an omnidirectional camera, and is stored in the memory 12. The display control unit 111 decides the viewpoint O2 of the second image G2 by applying, to the entire region of the second image, pattern matching using the image of the display region 301 after the scroll operation as a template. Then, the display control unit 111 may display the second image G2 on the display by setting the display region 302 centered on the viewpoint O2.

The present disclosure is useful for managing a construction site because a situation of the construction site can be checked remotely.

1. An information processing method in a computer, the method comprising:
displaying, on a display of an information terminal, a first image obtained by photographing a predetermined space on first date and time; and
when detecting an instruction to select second date and time different from the first date and time, displaying, on the display, a second image obtained by photographing the predetermined space on the second date and time,
wherein the second image is displayed on the display while having a default viewpoint being changed so as to match a viewpoint of the first image.

2. The information processing method according to claim 1, further comprising:
displaying, on the display, an overhead view image of the predetermined space, the overhead view image in which a plurality of photography point icons indicating photography points on the first date and time are displayed in a superimposed manner; and
detecting selection of one photography point icon from among the plurality of photography point icons,
wherein the first image is an image obtained by photographing at a photography point indicated by the one photography point icon.

3. The information processing method according to claim 1, wherein among a plurality of images obtained by photographing on the second date and time, the second image is an image obtained by photographing the predetermined space at a photography point closest to a photography point of the first image.

4. The information processing method according to claim 1, wherein
the change of the default viewpoint in the second image includes:
detecting a corresponding point of the viewpoint of the first image from the second image based on the first image; and
setting the detected corresponding point as a viewpoint of the second image.

5. The information processing method according to claim 1, wherein
the viewpoint of the first image is a center of a display region of the first image displayed on the display, and
a viewpoint of the second image is a center of a display region of the second image displayed on the display.

6. The information processing method according to claim 1, further comprising:
when detecting an instruction to scroll the first image, scrolling the first image in accordance with the scroll instruction, and scrolling the second image in conjunction with the scrolling of the first image.

7. The information processing method according to claim 1, further comprising:
when failing to detect a corresponding point of the viewpoint of the first image from the second image, detecting a corresponding point of the default viewpoint of the second image from the first image, and changing the viewpoint of the first image to the detected viewpoint and displaying the first image on the display.

8. The information processing method according to claim 1, wherein the predetermined space is a work site.

9. The information processing method according to claim 1, wherein the first image and the second image are displayed side by side on the display.

10. An information processing device comprising a processor,
wherein the processor
displays, on a display of an information terminal, a first image obtained by photographing a predetermined space on first date and time; and
when detecting an instruction to select second date and time different from the first date and time, displaying, on the display, a second image obtained by photographing the predetermined space on the second date and time,
the second image being displayed on the display while having a default viewpoint being changed so as to match a viewpoint of the first image.

11. A non-transitory computer readable recording medium storing an information processing program for causing a computer to execute a process of:
displaying, on a display of an information terminal, a first image obtained by photographing a predetermined space on first date and time; and
when detecting an instruction to select second date and time different from the first date and time, displaying, on the display, a second image obtained by photographing the predetermined space on the second date and time,
wherein the second image is displayed on the display while having a default viewpoint being changed so as to match a viewpoint of the first image.
